(19) United States
(12) Patent Application Publication
(10) Pub. No.: US 2015/0271337 A1
(43) Pub. Date: Sep. 24, 2015

(54) INTERNATIONAL DIALING THROUGH A RELAY

(71) Applicant: Talk.to FZC, Ras Al Khaimah (AE)

(72) Inventor: Bhavin Turakhia, Mumbai (IN)

(21) Appl. No.: 14/295,256

(22) Filed: Jun. 3, 2014

(30) Foreign Application Priority Data
Mar. 19, 2014 (IN) 906/MUM/2014

(51) Int. Cl. H04M 3/54; H04W 4/16

(52) U.S. Cl. CPC H04M 3/541; H04W 4/16

(57) ABSTRACT

In example embodiments, a system and method for international dialing through a relay is provided. A call is received from a device of a caller to a pool number. An identifier of the caller is identified from the call. A pool string is determined from the pool number whereby the pool string having one or more digits of the pool number. A destination string is identified to which a combination of the identifier of the caller and the pool string maps in a database whereby the destination string by itself is insufficient to obtain a destination number. The destination number is constructed using the destination substring and one or more digit keys associated with the call. The call is forwarded to the destination number.

### CROSS-REFERENCE TO RELATED APPLICATIONS

The present application claims the benefit of priority under 35 U.S.C. §119 to Indian Application No. 906/MUM/2014, filed on Mar. 19, 2014, which is incorporated herein by reference in its entirety.

### FIELD

The present disclosure relates generally to communications, and in a specific example embodiment, to providing dialing through a relay.

### BACKGROUND

When a user wants to call an individual internationally from his mobile device, the user typically dials the international phone number of the individual. The cost for the international call will typically be greater than a domestic or local call for the user. While some systems allow for cheaper calls using Voice-over-IP (VoIP), VoIP is typically available only where the user's mobile device has a good Internet connection. Additionally, the call quality of a VoIP call may be sometimes problematic.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for dialing through call connections may be implemented.

FIG. 2 is a block diagram illustrating an example embodiment of a user device.

FIG. 3 is a block diagram illustrating an example embodiment of a service provider system.

FIG. 4A is an example communication flow diagram for international dialing through a relay according to one embodiment.

FIG. 4B is an example communication flow diagram for international dialing through a relay according to another embodiment.

FIG. 4C is an example communication flow diagram for international dialing through a relay according to another alternative embodiment.

FIG. 4D is an example communication flow diagram for international dialing through a relay according to a further alternative embodiment.

FIG. 4E is an example communication flow diagram for international dialing through a relay according to another alternative embodiment.

FIG. 4F is an example communication flow diagram for international dialing through a relay according to another alternative embodiment.

FIG. 4G is an example communication flow diagram for international dialing through a relay according to a further alternative embodiment.

FIG. 5 is a flow diagram of an example method for providing a mapped pool number for a destination number to a user.

FIG. 6 is a flow diagram of an example method for providing international dialing through a relay.

FIG. 7 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing dialing (e.g., international dialing) through a relay. In example embodiments, a system and method for international dialing through a relay is provided. A call is received from a device of a caller to a pool number by a service provider system. An identifier of the caller is identified from the call. A pool string is determined from the pool number such that the pool string has one or more digits of the pool number. A destination string is identified to which a combination of the identifier of the caller and the pool string maps in a data store. The destination string by itself is insufficient (e.g., to a user or the service provider system) to obtain a destination number. The destination number is constructed using the destination substring and one or more digit keys associated with the call. The digit key indicates how to construct the destination number using the pool string, destination string, and, in some cases, an identifier corresponding to the caller (e.g., phone number of the user device of the caller) or information derived from DTMF tones. The call is forwarded to the destination number.

In some embodiments, a communication application may be provided on the user devices of the first user and the second user. The communication application can provide functionalities or advantages over a native calling application on the user device. For example, the use of the communication application may allow for a lower rate or lower cost on international communications (e.g., calls, text messages, or chat messages) such that whenever the user tries to initiate an international call, the communication application may request and obtain the pool number for local calling (e.g., in a local calling area relative to the user). The pool number may comprise a low cost alternative relative to calling the long distance number since the local number may be in a same county or area code as the user (and thus is a domestic low or no cost number).

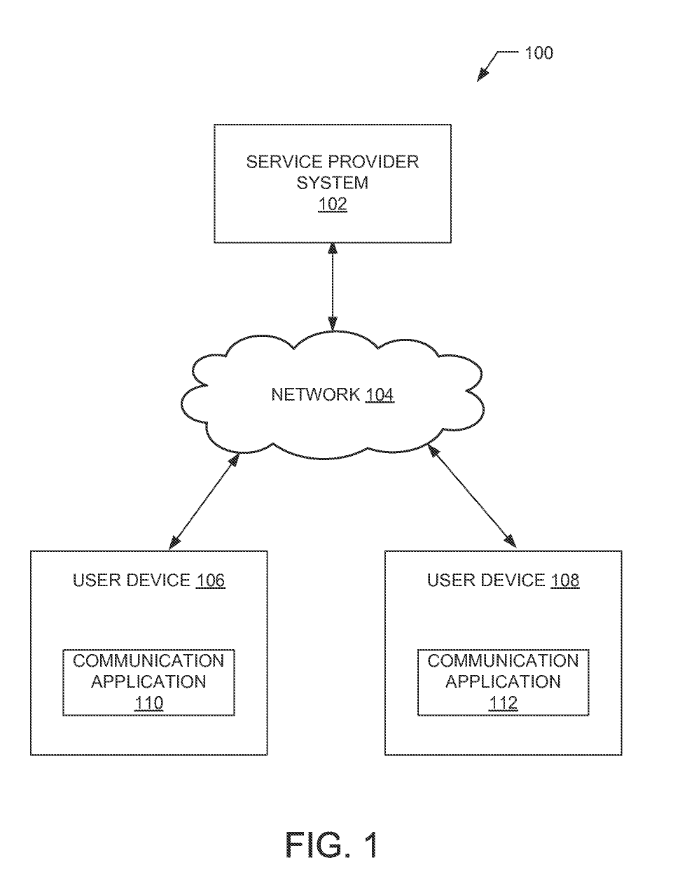

With reference to FIG. 1, a diagram illustrating an example environment 100 in which embodiments of a system for international dialing through a relay is provided. The environment 100 comprises a service provider system 102 coupled via a network 104 (e.g., the Internet, wireless network, cellular network, PSTN, or a Wide Area Network (WAN)) to a first user device 106 and a second user device 108. The first user device 106 is associated with a first user that is attempting to place an international call. In example embodiments, the first user may have downloaded or otherwise installed a communication application 110 on their user device 106 that communicates with the service provider system 102. The user device 106 may also have a native calling application for providing communication services. Thus, the user device 106 may comprise multiple applications for use in initiating a communication, and the user has an option to use any of the applications. The user device 106 may comprise a mobile phone, smartphone, laptop, tablet, or any other communication device that a user may utilize to store, access, or operate the communication application 110.

The second user device 108 is associated with a second user that may be a call recipient of the first user. In some embodiments, the second user may have downloaded or otherwise installed a communication application 112 on their user device 108 that communicates with the service provider system 102. The user device 108 may also have a native calling application for providing communication services. Thus, the user device 108 may comprise multiple applications for use in initiating a communication. The user device 108 may comprise a mobile phone, smartphone, laptop, tablet, or any other communication device that a user may utilize to store, access, or operate the communication application 112.

The communication applications 110 and 112 comprise pieces of functionality on the user devices 106 and 108 that provide functions or operations that allow the users of the user devices 106 and 108 to conduct an international call using a relay by the service provider system 102, as will be discussed in more detail below. In some embodiments, the service provider system 102 may provide the communication applications 110 and 112 to the respective user devices 106 and 108 (e.g., provide a downloadable version of the service application, electronically send the service application to the user device 106, or physically send to the user via a storage medium such as a CD ROM). Some embodiments may be practiced without the use of the communication application 110 on (e.g., being stored by, or being executed by) the user device 106 or the communication application 112 on the user device 108.

It is noted that the environment 100 shown in FIG. 1 is merely an example. For example, alternative embodiments may comprise any number of user devices 106 and 108 in the environment 100 and any number of service provider systems 102.

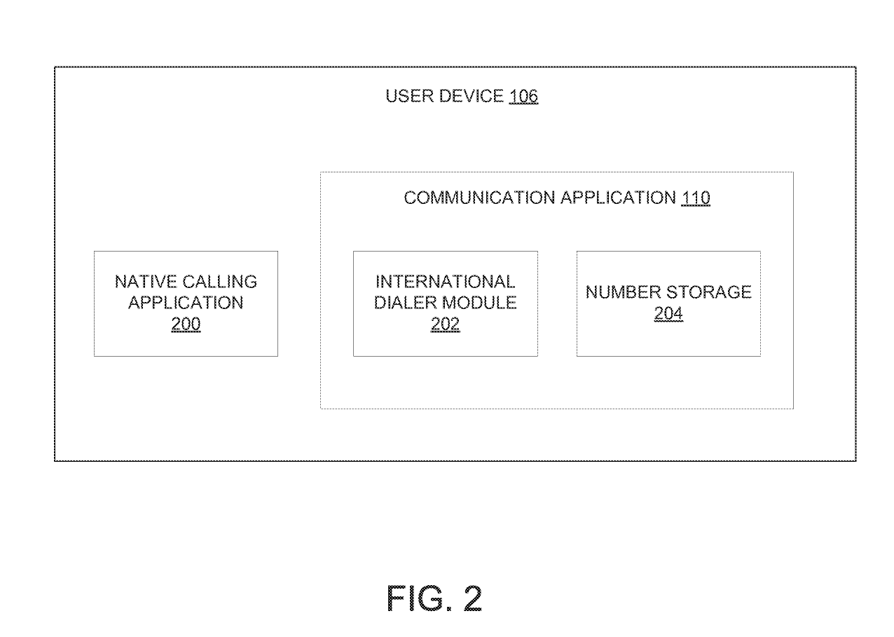

Referring now to FIG. 2, a block diagram illustrating an example embodiment of the user device 106 of the first user is shown. The user device 106 is illustrated having the communication application 110 installed thereon. The user device 106 may also include a native calling application 200. In some embodiments, the communication application 110 and the native calling application 200 may be one and the same. The communication application 110 may provide enhanced communication functionality and services to the user device 106. The communication application 110 may also initiate a call to the service provider system 102. Accordingly, the communication application 110 may comprise an international dialer module 202 and a number storage 204. It is noted that the user device 106 and the communication application 110 may comprise other modules not pertinent to example embodiments that are not shown or discussed.

The international dialer module 202 manages communications initiated by the user device 106 that are directed to international calling. Upon activation of the communication application 108, the international dialer module 202 allows the user of the user device 106 to dial an international number of a callee (e.g., the second user) or select the international number for the callee from stored contact information (e.g., from the number storage 204). Once the international number is entered and a call initiated (e.g., selecting a “dial” or “talk” button) from within the communication application 110, the international dial module 202 may send a request to the service provider system 102 to obtain a local pool string from which a local pool number may be derived. The pool string may comprise one or more digits of a pool number that can be used to conduct an international call at a low cost. In one embodiment, the request may comprise a destination string derived from the international number such that the destination string cannot be used to determine the international number. For example, the destination string may only contain the first 8 digits of the international number. Alternatively, if the local pool string has been previously assigned to the user device 106, the international dialer module 206 may take the destination string and check for the local pool string in the number storage 204. In yet a further embodiment, if the user attempts to dial the international number using the native call application 200, the communication application 110 may intercept the call and the international dialer module 202 may either send the request for the local pool string or perform a lookup in the number storage 204 for a previously stored local pool string that corresponds to the dialed international number. Once the local pool string is obtained by the international dialer module 202, the international dialer module 202 dials a local pool number derived from the local pool string. The derivation of the pool number will be discussed in more detail below. While example embodiments are discussed with respect to international calls, alternative embodiments may be directed to other forms of calls. For example, the call may be a long distance call within the same country.

In various embodiments, the user device 108 of the second user may also comprise a similar communication application (e.g., communication application 112) having similar functionalities. In an alternative embodiment, the second user device 108 may not comprise the communication application 112.

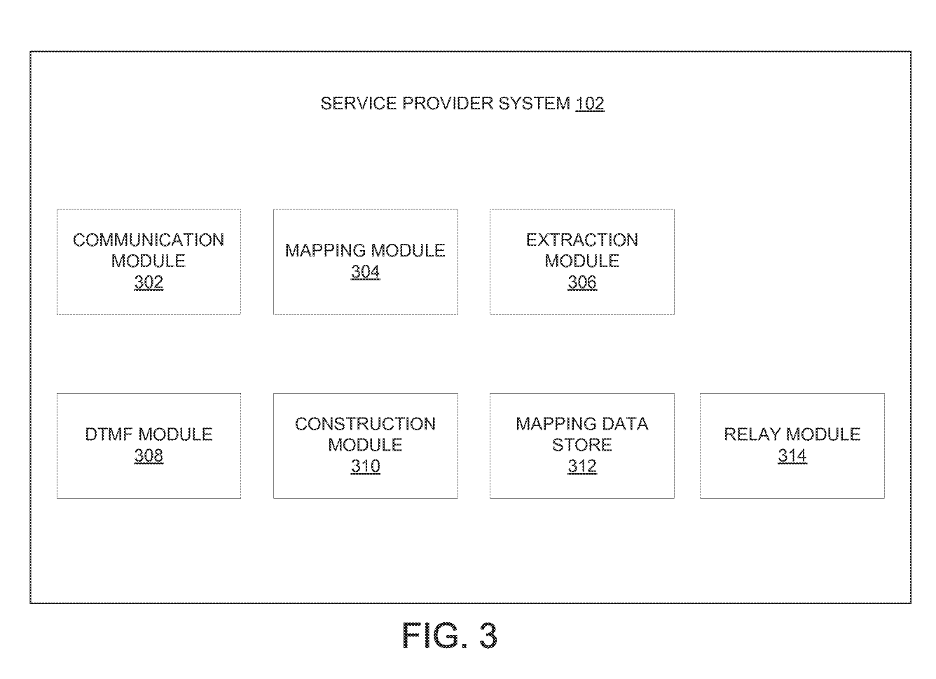

Referring now to FIG. 3, the service provider system 102 is shown in more detail. In example embodiments, the service provider system 102 may comprise one or more servers that provide communication functionalities and services including international dialing through a relay to users having the communication application 110 installed on their user device. To enable these functionalities and services, the service provider system 102 may comprise a communication module 302, a mapping module 304, an extraction module 306, a DTMF module 308, a construction module 310, a mapping data store 312, and a relay module 314 coupled in communication with each other. The service provider system 102 may comprise other components not pertinent to example embodiments that are not shown or discussed. Furthermore, alternative embodiments may comprise more, less, multiples of, or other modules for providing international dialing through a relay. Additionally, some functions of the modules may be combined or divided into two or more further modules.

The communication module 302 manages reception and responses for requests and calls from various user devices. In example embodiments, the communication module 302 receives an indication of a call from the first user to the second user. In some instances, the indication may indicate that the first user is attempting to call the second user using the international number for the second user and may include a request for a pool string that corresponds to a pool number in a local calling area (e.g., in a same area code or lower cost than a long distance number) of the first user. In other instances, the indication may indicate that the first user is calling the second user using a previously assigned pool string (stored at the first user device 108) that corresponds to the international number for the second user. If the indication includes the request for the pool string, the communication module 302 may obtain the pool string via the mapping module 304 and return the pool string to the device of the first user. In one embodiment, the pool string may be returned to the communication application 110 on the user device 106. In alternative embodiments, the pool string may be returned using SMS, an audio call, or any other form of communication.

In some embodiments, the communication module 302 may also receive requests to pre-assign pool string to the first device 108 from the communication application 110. For example, when the user initially downloads or installs the communication application 110 on their user device 108, the communication application 110 may request that all destination strings corresponding to international numbers in a contact list (e.g., address book) on the user device 108 be pre-assigned a pool string by sending such a request to the service provider system 102. In one embodiment, the communication application 110 may generate the destination string from the international numbers (e.g., convert an international number into a destination string). Additionally, each time a new contact is added to the contact list or modified that is associated with an international number, the communication module 302 may receive a request from the communication application 110 to pre-assign a pool string to the destination string corresponding to that international number.

The mapping module 304 manages the pool string at the service provider system 102. In example embodiments, the mapping module 304 determines a pool string to assign to a user that is local to the user. For example, the mapping module 304 may assign a pool string in the same area code as the user. If there is no pool string in the same local calling area (e.g., area code), the mapping module 304 may assign a pool string that is the least expensive for the user to call.

In example embodiments, the mapping module 304 receives a destination number to be mapped. The mapping module 304 then creates a destination string using the destination number. The destination string may comprise one or more digits of the destination number and, in some embodiments, may include more digits than the destination number. For example, a destination number may be 123-456-7899 and the destination string may be 123-456-789 or 123-456-75899.

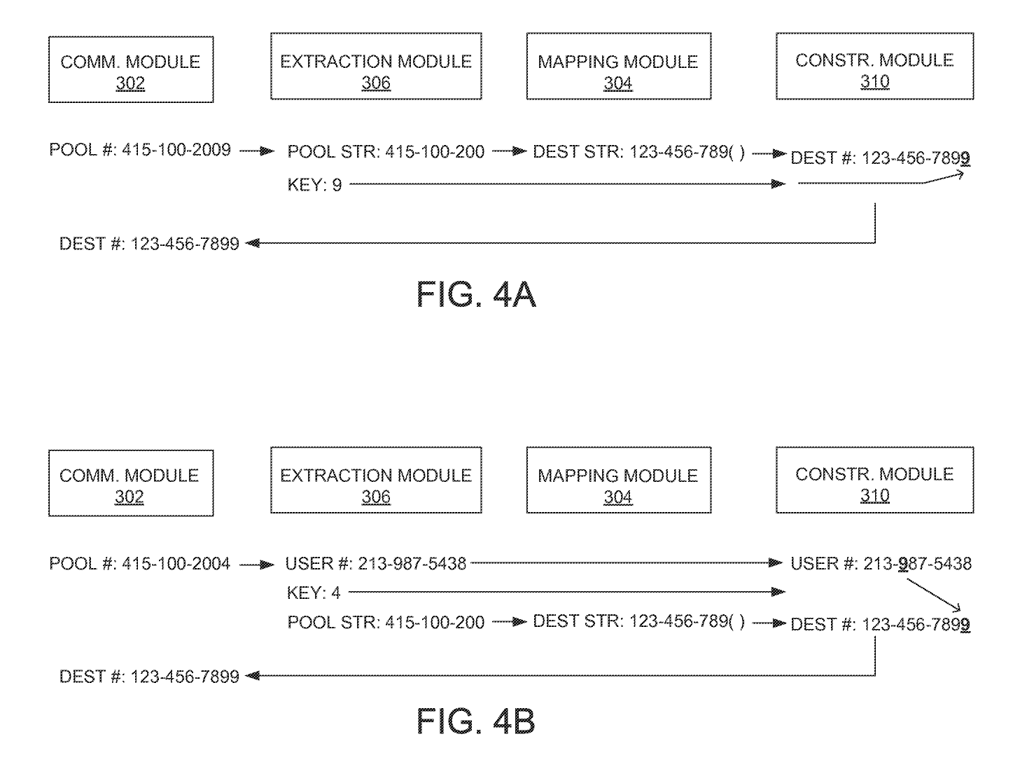

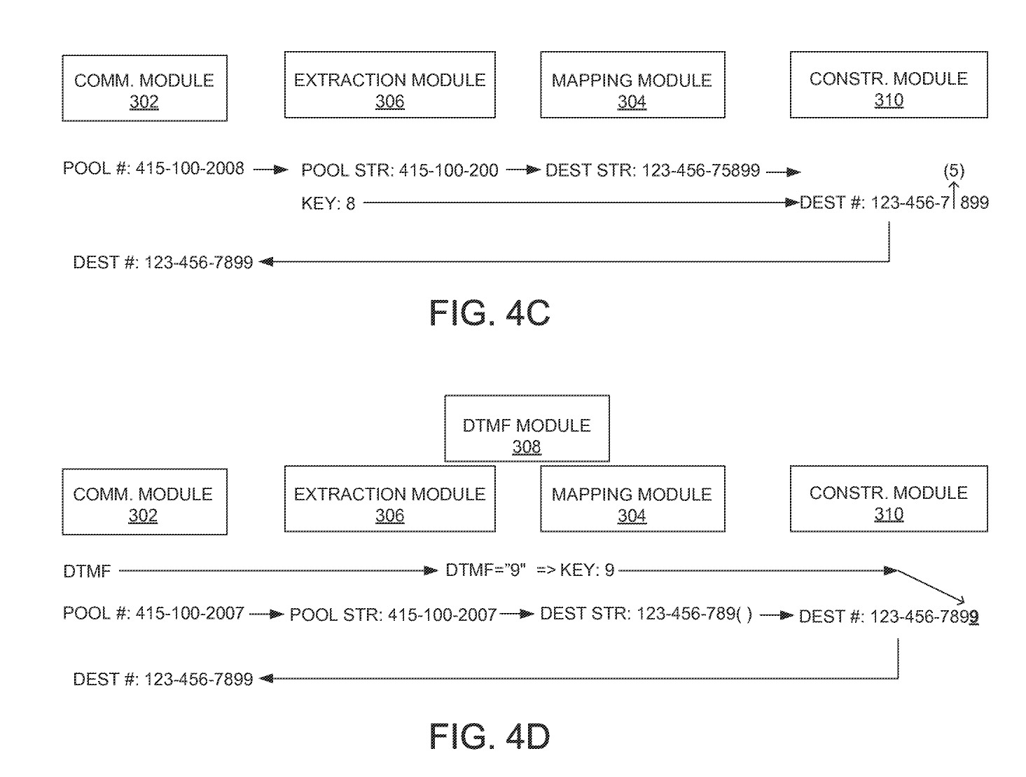

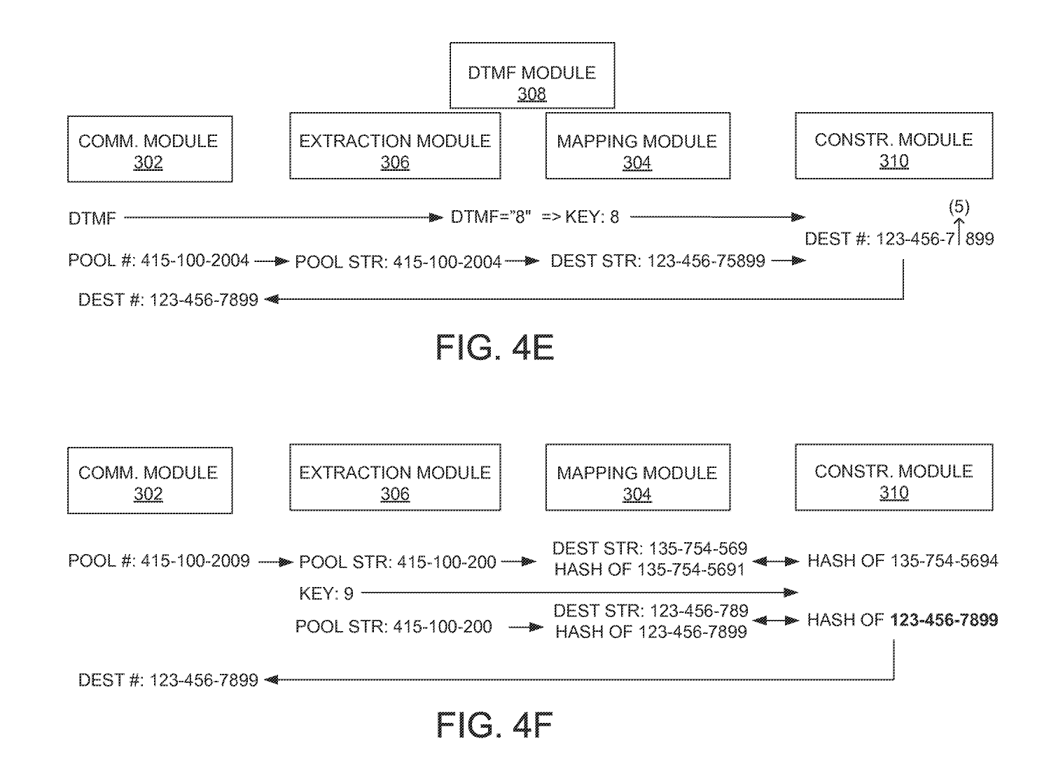

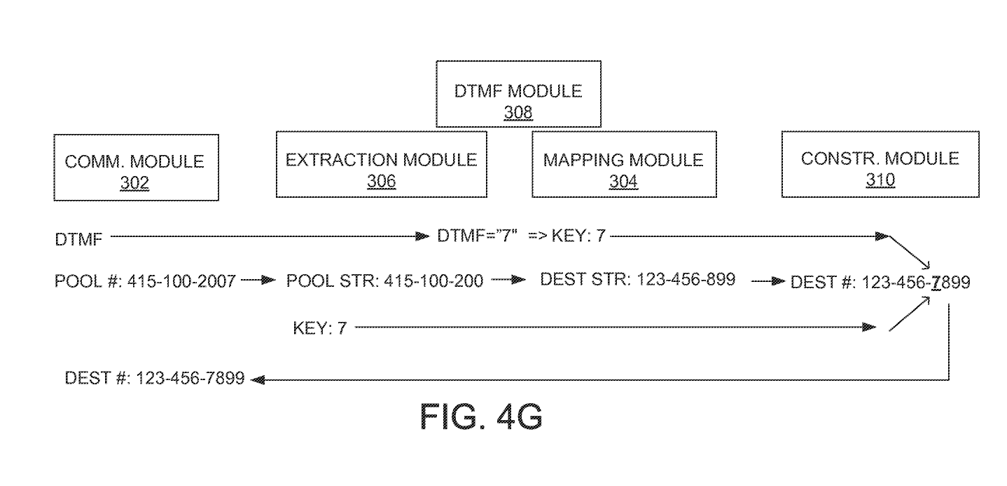

The destination string is then mapped by the mapping module 304 (e.g., linked, assigned, or otherwise correlated) to the pool string derived from an available pool number. The pool string may comprise one or more digits of the pool number and, in some cases, may be the pool number. In some embodiments, the pool string is selected by the mapping module 304 such that a digit key may be incorporated within the corresponding pool number. For example, if the pool number is 415-100-2004, the digit key may be the last digital “4,” and the pool string that is mapped to the destination string is 415-100-200. The digit key indicates how to construct the destination number using the pool string, destination string, and, in some cases, an identifier corresponding to the user (e.g., phone number of the user device 106 of the first user), or information derived from DTMF tones. The digit key may indicate one or more digits to be added to the destination string, one or more digits to be removed from the destination string, a position of a digit from a known set of digits to be removed from the destination string, a position of a digit from a known set of digits where a digit should be added to the destination substring, or any other data that may be used to construct a destination number from the destination string. The pool string and the destination string may then be stored by the mapping module 304 to the mapping data store 312. The mapping may expire after a predetermined period of time. Detailed examples of destination strings, pool strings, and digit keys will be discussed in conjunction with FIGS. 4A-4F below.

In an alternative embodiment, the mapping may be performed by the international dialer module 202. For example, the communication application 110 may obtain a plurality of available pool strings via the communication module 302 and the mapping module 304. The international dialer module 202 may determine and map a destination string and a pool string for each international number in the contact list, and send the mapping back to the service provider system 102. The communication module 302 receives the mapping, and the mapping module 304 may store the mappings to the mapping data store 312.

The extraction module 306 receives the call at a dialed pool number and may extract the digit key from the pool number (or otherwise determine the pool string). For example, if the pool number is 415-100-2004, the extraction module 306 may extract the digit key “4,” which is the last digit in the pool number. Additionally or alternatively, the extraction module 306 may determine pool substring, 415-100-200.

The DTMF module 308 analyzes dual-tone multi-frequency signaling (DTMF) tones received with a call to extract information. For example, the call made by the first user device 106 to the pool number may comprise DTMF tones that provide the digit key. Alternatively, the DTMF tones may provide or indicate a destination number construction method (as will be discussed in more detail below) that should be used in constructing the destination number using the pool string, destination string, and digit key.

The construction module 310 constructs the destination number based on the received call to the pool number (containing the assigned pool string) by the first user and using at least one digit key. Various construction methods for how the construction module 310 constructs the destination number will be discussed in more detail in connection with FIGS. 4A-4F below. In some embodiments, the construction method may be predetermined prior to the assigning of the pool string to the destination string. In other embodiments, the construction method may be communicated between the user device 106 and the service provider system 102 at any time (e.g., before assigning pool string, during the call to the pool number) using any method (e.g., SMS, Internet).

The mapping data store 312 may comprise a database of tables having tuples or mapping entries of attributes which indicate how to relay a call to a destination number. In example embodiments, a tuple or mapping entry may include at least a pool string, a destination string, and the user identifier of the first user (e.g., phone number of the user device 106). Because the mapping data store 312 only stores destination strings mapped to a pool string, the information in the mapping data store 312 is more secure than in embodiments where, for example, a destination number is mapped to a pool number. For example, if the mapping data store 312 is hacked, the hacker may not be able to construct the destination number based solely on the information stored in the mapping data store 312. Since the digit key(s) for each tuple or mapping entry is not mapped or indicated in the mapping data store 312, the hacker would be reduced to guessing what the destination numbers may be.

The relay module 314 relays the call from the pool number comprising the assigned pool string dialed by the user device 106 to the destination number that is derived by the construction module 310. As such, the relay module 314 receives the destination number derived by the construction module 310 and connects the first user to the second user.

FIG. 4A is an example communication flow diagram for international dialing through a relay according to one embodiment. In this embodiment, the digit key is the last digit in the pool number. Accordingly, the communication module 302 on the user device 106 of the first user calls the pool number 415-100-2009. The extraction module 306 receives the pool number and extracts or determines the digit key and the pool string. In this embodiment, the digit key is “9” and the pool string is 415-100-200. Using the pool string, the mapping module 304 accesses the mapping data store 312 and determines the destination string mapped to the pool string. In some cases, the user identifier may also be used to determine the mapping (e.g., pool string for the first user is this destination substring). In the present example, the destination string is 123-456-789, which is one number short of a destination number. In this embodiment, the digit key provides the last digit of the destination number. As a result, the destination number is 123-456-7899. The relay module 314 may then connect the first user device 106 to the destination number. While the present example appends the digit key to the end of the destination string, alternative embodiments may add the digit key to another position in the destination string. Furthermore, more than one digit may be added to the destination string in alternative embodiments. The method of appending the digit, the number of digits to append, and/or a location of the digit key may be predetermined or communicated by the user device 106 to the service provider system 102 at any time.

FIG. 4B is an example communication flow diagram for international dialing through a relay according to another embodiment. In this embodiment, the digit key points to a position in the identifier of the first user (e.g., phone number of the first user) that is to be appended to the destination string. Accordingly, the communication module 302 calls the pool number 415-100-2004. The extraction module 306 receives the pool number and extracts or determines the digit key and the pool string. In this embodiment, the digit key is the last digit in the pool number which is “4,” and the pool string is 415-100-200. Using the pool string, the mapping module 304 accesses the mapping data store 312 and determines the destination string mapped to the pool substring. In the present example, the destination substring is 123-456-789, which is one number short of a destination number.

Using the digit key “4”, the construction module 310 determines the fourth digit in the identifier of the first user. In the present example, the identifier of the first user is 213-987-5438, and the fourth digit is “9.” This fourth digit provides the last digit of the destination number. As a result, the destination number is 123-456-7899. The relay module 314 may then connect the first user device 106 to the destination number. Furthermore, more than one digit may be added to the destination string in alternative embodiments. In yet another embodiment, a particular digit from the identifier of the first user may always be the digit key (e.g., the fifth digit is always the digit key). The method of appending the digit, the number of digits to append, a location of the digit key, and/or the particular digit that is always the digit key may be predetermined or communicated by the user device 106 to the service provider system 102 at any time.

FIG. 4C is an example communication flow diagram for international dialing through a relay according to another embodiment. In this embodiment, the digit key points to a position in the destination string where a digit should be removed. As such, the destination string in this embodiment may comprise more digits than the destination number. Accordingly, the communication module 302 calls the pool number 415-100-2008. The extraction module 306 receives the pool number and extracts or determines the digit key and the pool string. In this embodiment, the digit key is “8” and the pool string is 415-100-200. Using the pool string, the mapping module 304 accesses the mapping data store 312 and determines the destination string mapped to the pool string. In example embodiments, the user identifier may also be used to determine the mapping (e.g., pool string for the first user is this destination string). In the present example, the destination string is 123-456-75899. Using the digit key “8,” the eighth digit in the destination string is removed. Thus, the second “5” is removed and the destination number is 123-456-7899. The relay module 314 may then connect the first user device 106 to the destination number. It is noted that more than one digit may be removed from the destination string in alternative embodiments. While the embodiments discussed in FIGS. 4A-4C has the last digit in the pool number being the digit key, alternative embodiments may use any position in the pool number as the digit key (e.g., the third number, the fifth number).

FIG. 4D is an example communication flow diagram for international dialing through a relay according to a further embodiment. In this embodiment, the digit key is received via DTMF. In example embodiments, the DTMF may be received with the call from the communication module 302 when the communication module 302 calls the pool number. Accordingly, the communication module 302 calls the pool number 415-100-2007. In this embodiment, the pool string may be the entire pool number or any one or more of digits of the pool number that may be mapped to a destination string. Using the pool string, the mapping module 304 accesses the mapping data store 312 and determines the destination string mapped to the pool string. In the present example, the destination string is 123-456-789, which is one number short of a destination number.

In the present example, the DTMF may indicate that the digit key is “9,” and the digit key provides the last digit of the destination number. As a result, the “9” is appended to the destination string and the destination number is 123-456-7899. The relay module 314 may then connect the first user device 106 to the destination number. It is noted that in alternative embodiments, the digit key may be added to the destination string in a different position.

Similar to the embodiment discussed in FIG. 4C, the digit key obtained from DTMF may, in an alternative embodiment, indicate a position in the destination string where a digit should be removed. As such, the destination string in this embodiment may comprise more digits than the destination number. Accordingly, the communication module 302 calls the pool number 415-100-2004 in the embodiment of FIG. 4E. The extraction module 306 receives the pool number and determines the pool string. In this embodiment, the pool string may be the entire pool number or any one or more of digits of the pool number that may be mapped to a destination string. Using the pool string, the mapping module 304 accesses the mapping data store 312 and determines the destination string mapped to the pool string. In the present example, the destination string is 123-456-75899. Using the digit key obtained from DTMF (e.g., “8”), the eighth digit in the destination string is removed. Thus, the second “5” is removed and the destination number is 123-456-7899. The relay module 314 may then connect the first user device 106 to the destination number. More than one digit may be removed from the destination string in alternative embodiments.

FIG. 4F provides an embodiment that uses derivatives to store and construct the destination number and allows a same pool string and number to be used for different destination numbers for the same user. As such, the mapping data store 312 stores a mapping of pool strings to destination strings plus a one way hash of the destination number. For example, the mapping data store 312 may store a tuple or mapping entry as [pool string; destination string, hash destination number]. In the embodiment shown in FIG. 4F, the tuples may include [415-100-200; 135-754-569; hash of 134-754-5691] and [415-100-200; 123-456-768; hash of 123-456-7899]. As such, the communication module 302 on the user device 106 of the first user calls the pool number 415-100-2009. The extraction module 306 receives the pool number and extracts or determines the digit key and the pool string. In this embodiment, the digit key is “9” and the pool string is 415-100-200. Using the pool string, the mapping module 304 accesses the mapping data store 312 and determines there are two destination strings that match the pool string. The construction module 310 appends the digit key “9” to both destination strings and hashes the resulting number. The result of the hash will match a stored hash for one of the tuples. In the present case, the hash of 123-456-7899 matches the tuple stored in the mapping data store 312 for the number 123-456-7899. Therefore, the destination number is determined to be 123-456-7899. The relay module 314 may then connect the first user device 106 to this destination number.

In an alternative embodiment, a same string may be assigned to different destination strings of destination numbers belonging to the same caller by providing an additional set string. The set string may be used to determine which map entry to use in the identifying of the destination string, whereby the set string along with the destination string is insufficient to obtain the destination number. In one embodiment, the set string is the digit key. For example, the same pool string of 415-100-200 may be assign to a destination string of 134-754-569 (stored with a set string of 1) and a destination string of 123-456-789 (stored with a set string of 2). In one embodiment, depending on whether the digit key is between 0-4 or 5-9, it may be deemed to belong to set 1 or set 2. If the digit key is 7, then the destination string is determined to be 123-456-789. A second digit key may be used to, for example, provide the digit to be appended to the destination string. It is noted that in some embodiments, the set string is not a number (e.g., a DTMF tone).

FIG. 4G is an example communication flow diagram for international dialing through a relay according to another embodiment. In this embodiment, two digit keys are used in constructing the destination number. A first digit key may be received via DTMF from the communication module 302 when the communication module 302 calls the pool number, and a second digit key may be derived from the pool number. Accordingly, the communication module 302 calls the pool number 415-100-2007. The extraction module 306 receives the pool number and extracts or determines the digit key and the pool string. In this embodiment, the digit key is “7” and the pool string is 415-100-200. Using the pool string, the mapping module 304 accesses the mapping data store 312 and determines the destination string mapped to the pool string. In the present example, the destination string is 123-456-899, which is one number short of a destination number.

In the present example, the DTMF may indicate that the digit key is “7,” and the digit key provides a position in the destination string where a digit should be appended. As a result, the “7” indicates that a digit should be added to the seventh position in the destination string. The digit key derived from the pool number is the digit to be appended in the 7^{th} position in the destination string. As a result, the destination string is 123-456-7899. The relay module 314 may then connect the first user device 106 to the destination number.

It is noted that the embodiment presented in FIG. 4G illustrates just one example of using more than on digit key in constructing the destination number. As an alternative to this embodiment, for example, the digit key derived from DTMF may provide the digit to be appended and the digit key derived from the pool number may provide the position where the digit is to be appended. Additionally, any number of digit keys may be used. For example, DTMF may indicate two positions where digits are to be added: a first digit may be derived from the pool number as discussed in the embodiment of FIG. 4A and a second digit may be obtained from the user identifier as discussed in the embodiment of FIG. 4B. Alternatively, one or more digits may be removed from the destination string while one or more further digits may be added to the destination string. Further still, the digit key may be provided by the communication application 110 on the user device 106. For example, the communication application 110 may provide an SMS message to the service provider system 102 indicating the digit key to be used to construct the destination number. Any combination of these methods may be used to derive the destination number.

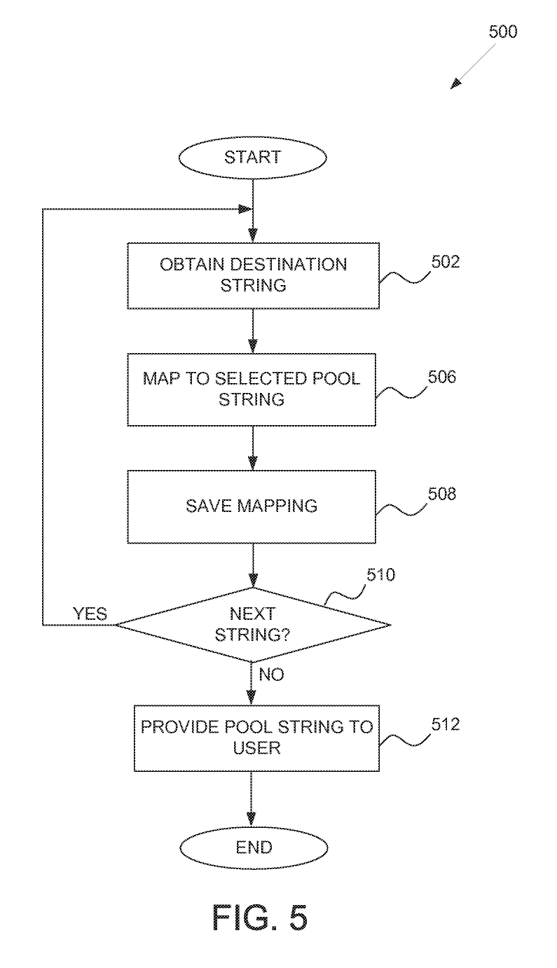

FIG. 5 is a flow diagram of an example method 500 for providing a mapped pool string for a destination string to a user. The operations of the method 500 may be performed by components of the service provider system 102. In operation 502, a destination string to be mapped is received or obtained. For example, the mapping module 304 receives the destination string to be mapped from the user device 106. The destination string may comprise one or more digits of the destination number and, in some embodiments, may include more digits than the destination number. For example, a destination number may be 123-456-7899 and the destination string may be 123-456-789 or 123-456-75899.

The destination string is then mapped to a pool string derived from an available pool number in operation 506. Accordingly, the mapping module 304 may map the destination string to the pool string. The pool string may comprise one or more digits of the pool number and, in some cases, may be the pool number. For example, a pool number 415-100-2004 is reduced to a pool string 415-100-200 and is mapped to the destination string.

The pool string and the destination string may then be stored to the mapping data store 312 in operation 508. The mapping may be stored, for example, as tuples that include at least the pool string and the destination string, but does not indicate the destination number.

In operation 510, a determination is made as to whether a next destination string should be mapped. For example, if a plurality of international numbers from a contact list is to be mapped, then a next destination string will be available for mapping. If there is a next destination string to be mapped, then the method returns to operation 502. However if there are no further destination strings to be mapped, then the pool strings may be provides to the user device 106.

In an alternative embodiment, the mapping may be performed by the international dialer module 202 of the user device 106. For example, the communication application 110 may obtain a plurality of available pool strings and/or numbers via the communication module 302 and the mapping module 304. The international dialer module 202 may determine and map a destination string and a pool string for each international number in the contact list, and send the mapping back to the service provider system 102 for storage. The communication module 302 receives the mapping, and the mapping module 304 may store the mappings to the mapping data store 312.

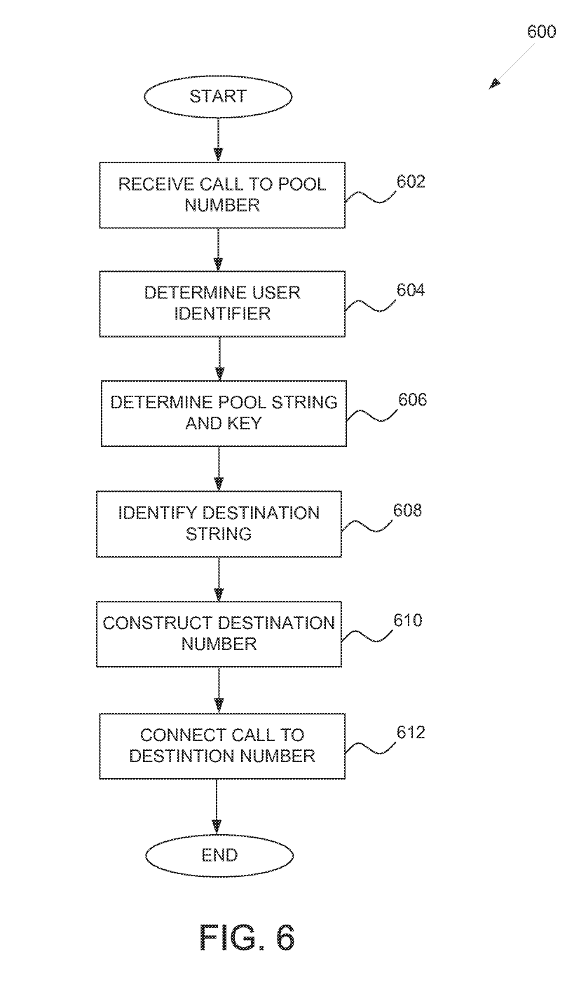

FIG. 6 is a flow diagram of an example method 600 for providing international dialing through a relay. Operations of the method 600 may be performed by various components of the service provider system 102. Accordingly, a call to a pool number is received in operation 602. In example embodiments, the call may be received by the communication module 302.

The user identifier is determined in operation 604. In example embodiments, the communication module 302 may know or identify the identifier from the call (e.g., caller ID). In other embodiments, the communication application 110 on the user device 106 may communicate the user identifier to the communication module 302.

In operation 606, a pool string and/or a digit key is determined from the pool number. In example embodiments, the extraction module 306 receives the pool number and extracts or determines the digit key and the pool string.

Using the pool string, the destination string is identified in operation 608. Accordingly, the mapping module 304 accesses the mapping data store 312 and determines the destination string mapped to the pool string. In some cases, the user identifier may also be used to determine the mapping (e.g., pool string for the first user is this destination substring).

In operation 610, the destination number is constructed from the destination string and the digit key. In example embodiments, the construction module 310 constructs the destination number by, for example, adding a digit or removing a digit from the destination string.

The call is then connected to the destination number in operation 612. Accordingly, the relay module 314 may connect the first user device 106 to the constructed destination number.

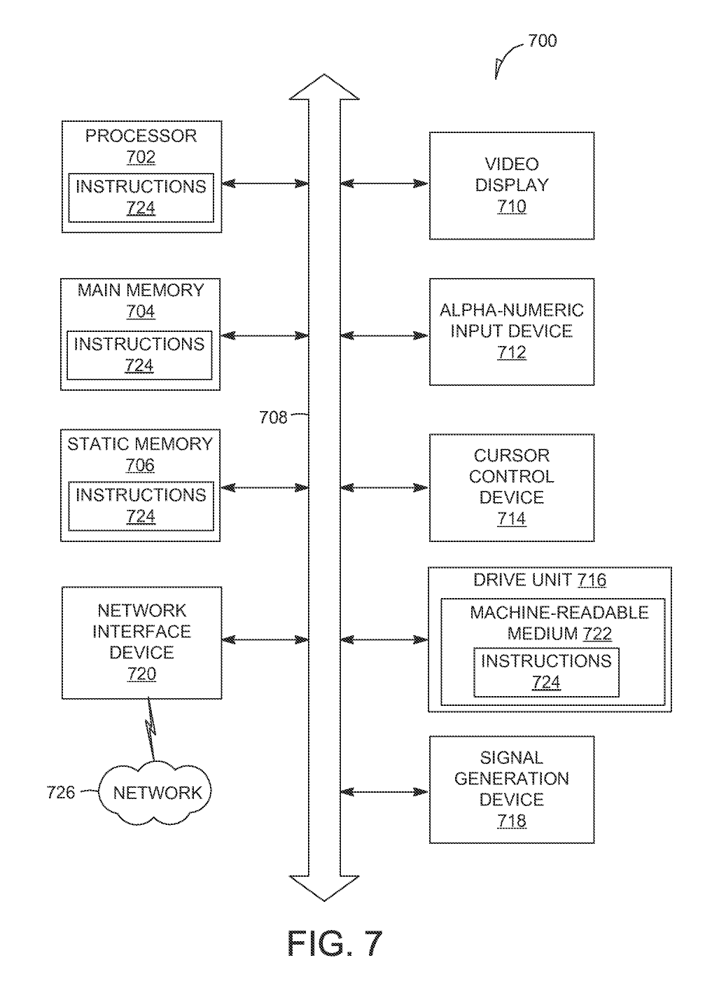

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system and within which instructions 724 (e.g., software, a program, an application, an applet, an app, or other executable code) for causing the machine 700 to perform any one or more of the methodologies discussed herein may be executed. In alternative embodiments, the machine 700 operates as a standalone device or may be connected (e.g., networked) to other machines. In a networked deployment, the machine 700 may operate in the capacity of a server machine or a client machine in a server-client network environment, or as a peer machine in a peer-to-peer (or distributed) network environment. The machine 700 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 724, sequentially or otherwise, that specify actions to be taken by that machine. Further, while only a single machine is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The machine 700 may further include a graphics display 710 (e.g., a plasma display panel (PDP), a light emitting diode (LED) display, a liquid crystal display (LCD), a projector, or a cathode ray tube (CRT)). The machine 700 may also include an alpha-numeric input device 712 (e.g., a keyboard), a cursor control device 714 (e.g., a mouse, a touchpad, a trackball, a joystick, a motion sensor, or other pointing instrument), a storage unit 716, a signal generation device 718 (e.g., a speaker), and a network interface device 720.

The storage unit 716 includes a machine-readable medium 722 on which is stored the instructions 724 embodying any one or more of the methodologies or functions described herein. The instructions 724 may also reside, completely or at least partially, within the main memory 704, within the processor 702 (e.g., within the processor's cache memory), or both, during execution thereof by the machine 700. Accordingly, the main memory 704 and the processor 702 may be considered as machine-readable media. The instructions 724 may be transmitted or received over a network 726 via the network interface device 720.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 700), such that the instructions, when executed by one or more processors of the machine (e.g., processor 702), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 724 may further be transmitted or received over a communications network 726 using a transmission medium via the network interface device 720 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving a call from a caller to a pool number;
determining an identifier of the caller from the call;
determining a pool string from the pool number, the pool string having one or more digits of the pool number;
identifying a destination string to which a combination of the identifier of the caller and the pool string maps in a data store, the destination string by itself being insufficient to obtain a destination number;
constructing, using a hardware processor, the destination number using the destination substring and one or more digit keys associated with the call; and
forwarding the call to the destination number.

2. The method of claim 1, wherein the constructing comprises adding one or more digits to the destination string using the one or more digit keys.

3. The method of claim 1, wherein the constructing comprises removing one or more digits from the destination string using the one or more digit keys.

4. The method of claim 1, wherein the one or more digit keys are obtained from the pool number.

5. The method of claim 1, wherein the one or more digit keys are obtained from DTMF tones obtained on the call.

6. The method of claim 1, wherein the one or more digit keys are obtained from the identifier of the caller.

7. The method of claim 1, wherein the one or more digit keys are obtained from a communication application installed on a device of the caller that is used to make the call.

8. The method of claim 1, wherein the one or more digit keys comprise one or more digits to be added to the destination string.

9. The method of claim 1, wherein the one or more digit keys comprise one or more digits to be removed from the destination string.

10. The method of claim 1, wherein the one or more digit keys comprise a position of a digit to be extracted from a known set of digits to be added to the destination substring.

11. The method of claim 1, wherein the one or more digit keys comprise data to be used for manipulation of the destination substring to obtain the destination number.

12. The method of claim 1, further comprising:
obtaining one or more destination numbers from the caller;
creating a destination string for each of the one or more destination numbers, the destination string being insufficient by itself to obtain the destination number;
selecting a pool string from a plurality of pool numbers for each of the one or more destination strings, the pool string having one or more digits of the pool number, and
saving a map entry for each of the one or more destination numbers, the map entry comprising the selected pool string, the destination string, and the identifier of the caller, each map entry being insufficient to derive the corresponding destination number.

13. The method of claim 12, further comprising assigning a same pool string to different destination strings belonging to different callers.

14. The method of claim 12, further comprising assigning a same pool string to different destination strings belonging to the caller, wherein an additional set string is stored along with the map entry, wherein the set string is used to determine which map entry to use in the identifying the destination string, the set string along with the map entry being insufficient to obtain the destination number.

15. The method of claim 12, further comprising providing the map entry to a communication application installed on the device of caller, the providing occurs over the Internet or using SMS.

16. The method of claim 12, wherein the saving the map entry is triggered by a selection from the group consisting of installation of a communication application on the device of the caller, the caller adding or modifying a contact in a contact list, the caller dialing a number, and receiving a request from a communication application on the device of the caller.

17. The method of claim 12, wherein the map entry is valid for a predetermined period of time.

18. The method of claim 12, further comprising
assigning a same pool string to different destination strings belonging to the caller, wherein an additional one way derivative of each of the one or more destination numbers, is stored along with each corresponding map entry, wherein the identifying results in a plurality of destination strings,
the constructing comprising:
converting the plurality of destination strings into a plurality of destination numbers using the one or more digit keys associated with the call;
retrieving a plurality of map entries corresponding to the pool string; and
comparing a one way derivative of each of the plurality of map entries with a one way derivative of each of the plurality of destination numbers to determine a match that identifies the destination number.

19. A machine-readable storage medium not having any transitory components, the machine-readable storage medium storing instructions that, when executed by the at least one processor of a machine, cause the machine to perform operations comprising:
receiving a call from a device of a caller to a pool number;
determining an identifier of the caller from the call;
determining a pool string from the pool number, the pool string having one or more digits of the pool number;
identifying a destination string to which a combination of the identifier of the caller and the pool string maps in a database, the destination string by itself being insufficient to obtain a destination number;
constructing the destination number using the destination substring and one or more digit keys associated with the call; and
forwarding the call to the destination number.

20. A system comprising:
a hardware processor;
a communication module to receive a call from a device of a caller to a pool number and to determine an identifier of the caller from the call;
a mapping module to determine a pool string from the pool number, the pool string having one or more digits of the pool number and to identify a destination string to which a combination of the identifier of the caller and the pool string maps in a database, the destination string by itself being insufficient to obtain a destination number;
a construction module to construct, using the hardware processor, the destination number using the destination substring and one or more digit keys associated with the call; and
a relay module to connect the call to the destination number.
